(19) United States
(12) Patent Application Publication
(10) Pub. No.: US 2008/0205840 A1
(43) Pub. Date: Aug. 28, 2008

(54) Plastic Optical Member and Producing Method Thereof

(75) Inventors: Akira Wakabayashi, Kanagawa (JP); Shuji Nakata, Kanagawa (JP); Yoshisada Nakamura, Shizuoka (JP); Yuka Hiwatashi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/666,547

(22) PCT Filed: Oct. 26, 2005
(86) PCT No.: PCT/JP05/20055

§ 371 Date: Apr. 11, 2008

(30) Foreign Application Priority Data
Oct. 28, 2004 (JP) 2004-314324

(51) Int. Cl. G02B 6/036; B29D 11/00

(52) U.S. Cl. 385/128; 264/1.24

(57) ABSTRACT

A clad pipe (70) is produced by heating PVDF to 180° C., and then this PVDF being extruded from a melt-extrusion device. The clad pipe (70) has a square cross-section whose sides L1 are 20 mm length, and in a center thereof, there is a square hole. In the square hole, a core (72) mainly includes PMMA is formed. Accordingly, a preform (12) having a clad (71) of PVDF and the core (72) of PMMA is obtained. The preform (12) is heat-soften-drawn at 210° C. A drawing ratio is 1600. Finally, an optical member (14) having a 0.5 mm square cross-section is obtained.

### TECHNICAL FIELD

The present invention relates to a plastic optical member and a method for producing the plastic optical member.

### BACKGROUND ART

Recent development in communication industry, the demand for the plastic optical transmission medium with lower transmission loss and low manufacture cost has been increased. The plastic optical transmission medium has merits of design facility and low manufacture cost, compared with a silica glass optical transmission medium with identical structure. Especially, the plastic optical transmission medium, entirely composed of a plastic material, is suitable for producing an optical transmission medium with a large diameter at a low cost, because the plastic has advantages in excellent flexibility, light weight and high machinability, compared with the silica glass. Accordingly, it is planned to use the plastic optical transmission medium for short-distance purpose in which the transmission loss is small (for example, Japanese Laid-Open Patent Publication (JP-A) No. 61-130904).

The plastic optical transmission medium is composed of a core formed from a plastic, and an outer shell (referred to as “clad”) that is formed from a plastic having smaller refractivity than the core. The plastic optical transmission medium is manufactured, for example, by forming a tubular clad (referred to as “clad pipe”) by melt-extrusion, and by forming the core in the clad pipe. A graded index (GI) type plastic optical transmission medium, in which the refractive index in the core gradually decreases from the center to the surface of the core, has high transmission band and high transmission capacity. Various methods for manufacture of the GI type plastic optical transmission medium are disclosed. For instance, U.S. Pat. No. 5,541,247 (counterpart of Japanese Patent No. 3332922) describes a method to manufacture the GI type plastic optical transmission medium by forming a base body (hereinafter referred to “preform”) by use of interfacial gel polymerization, and then by melt-drawing the preform in a heating furnace.

It is planned to use the optical transmission medium for communication, illumination, decoration, image reading, image output and the like. For example, in U.S. Pat. Nos. 5,548,670 and 5,542,017 (counterparts of Japanese Patents Nos. 3162398 and 3184219), the optical transmission medium is used for a light guide. The light guide contains light scattering particles in an optical medium such as PMMA (polymethylmethacrylate) or the like. Accordingly, the incoming light entering from one end of the light guide is transmitted toward the other end of the light guide, with being scattered by the particles. Since the light transmission is performed with scattering the light by the particles in the optical medium, in addition with total reflection at an interface of a periphery of the light guide and a surrounding medium (such as air or the clad), the light having more uniformed intensity can be outputted from the light exit face of the light guide, compared with a light transmission only with the total reflection. Accordingly, this type of the light guide is used as an optical bus, which has one input section for optical signal at one end face, and plural output section at the other end face (refer to Japanese Patent Laid-Open Publication No. 10-123350). The optical signal input into the input section is distributed toward the respective plural output section as the same signal. This types of light guides are used also for forming illumination light in a liquid crystal display and the like (refer to U.S. Pat. Nos. 5,548,670 and 5,542,017, and Japanese patent No. 3215218).

In general, many of the optical transmission mediums have circular cross-sectional shape. However, for particular purposes, the cross-sectional shape of the optical transmission medium is preferably non-circular, such as rectangular or elliptic. For example, in Japanese Patent Laid-Open Publication 2004-252441, an optical transmission medium having an elliptic cross-sectional shape is proposed.

The optical transmission medium with the non-circular cross-section is produced by processing an optical transmission medium with a circular cross-section. Although there is a case that the single optical transmission medium is used alone, it is often the case that plural optical transmission mediums are assembled especially for parallel signal transmission, image reading, image output or the like. The assembly of the optical transmission mediums is produced by heat-pressing the arranged optical transmission mediums (refer to Japanese Patent Laid-Open Publication No. 6-317716), coating the arranged optical transmission mediums (refer to Japanese Patent Laid-Open Publication No. 2000-338377) or the like. In addition, Japanese Patent Laid-Open Publication No. 2001-166165 proposes a method for producing an optical transmission medium with use of photoresist or etching.

The methods as described in each patent document needs special processing device for producing the optical transmission medium. The use of the special processing device corresponding to each type of optical member increases the manufacturing cost and decreases the manufacturing efficiency. In addition, a high processing accuracy is required for micromachining the optical member, and the micromachining reduces the manufacturing efficiency.

An object of the present invention is to provide a plastic optical member having non-circular cross-sectional shape at low cost. In addition, another object of the present invention is to provide a method for producing a plastic optical member having non-circular cross-sectional shape with a high accuracy at low cost.

### DISCLOSURE OF INVENTION

In order to achieve the objects and other objects, a method for producing a plastic optical member of the present invention comprises following steps. At first, a preform is formed from polymer, a cross-sectional shape of the preform being non-circular. Then the preform is heat-drawn to form the plastic optical member, the cross-sectional shape of the preform being approximately similar to that of the plastic optical member. Preferably, the cross-sectional shape of the plastic optical member is one of a polygon, a closed curve, or a combination of line and curve. The preform is produced by melt-extrusion.

The preform is a preform piece assembly constituted by assembling plural preform pieces. The preform piece assembly includes at least one secondary preform piece formed by heat-drawing a primary preform piece formed from polymer. The preform piece assembly is constituted by assembling plural kinds of preform pieces having different shapes or optical properties.

The preform piece includes a core to be a light transmitting path and a clad having a refraction index rower than that of the core. The clad surrounds the core. Preferably, the preform piece further includes a protector. The protector surrounds the clad.

The preform piece assembly is constituted by disposing a separating member between the preform pieces, and the separating member allows separating the preform pieces after the heat-drawing. The separating member contains a light shielding material. The core is formed mainly from (meth) acrylic ester, and the clad mainly includes fluorine resin. Further, the protector is formed mainly from (meth) acrylic ester. At least one of the core has a refractive index profile, in which a refractive index changes from a center to a periphery of the core. Preferably, the refractive index profile is a graded index type, in which the refractive index gradually decreases from the center to the periphery of the core in a continuous fashion. Also preferably, the refractive index profile is a multi-step index type, in which the refractive index gradually decreases from the center to the periphery of the core in a step-wise fashion. In addition, it is preferable that the core includes light scattering particles.

The preform piece assembly is constituted by adhering the preform pieces each other. It is preferable that the preform piece assembly is constituted by welding outer peripheries of the preform pieces each other. The welding is performed by heat before the heat-drawing, or by heat in the heat-drawing. Preferably, the heat-drawing is performed at a heating temperature T in a range of 80° C.≦T≦500° C. Particularly, the heat-drawing is performed at a heating temperature T in a range of (Ts−50° C.)≦T≦(Ts+50° C.), When Ts is a softening temperature of a main polymer of the preform.

A plastic optical member formed by the method of the present invention comprises a core having a circular cross-section and a clad having an approximately polygonal cross-section. Preferably, the cross-section of the clad has a square, rectangular or regular hexagonal shape.

A plastic optical member of the present invention comprises a core having a circular cross-section and a protector having an approximately polygonal cross-section. Preferably, the cross-section of the protector has a square, rectangular or regular hexagonal shape.

A plastic optical member of the present invention comprises a core having an approximately polygonal cross-section and a clad having an approximately polygonal cross-section. Preferably, the cross-section of the core has a square or rectangular shape, and the cross-section of the clad has a square, rectangular or regular hexagonal shape.

A plastic optical member of the present invention comprises a core having an approximately polygonal cross-section and a protector having an approximately polygonal cross-section. Preferably, the cross-section of the core has a square or rectangular shape, and the cross-section of the protector has a square, rectangular or regular hexagonal shape. In addition, the cross-section of the clad preferably has a circular shape.

A plastic optical member of the present invention comprises plural cores arranged in two-dimension in a clad. It is preferable that a cross-section of the core has a circular shape, and a cross-section of the clad has a square, rectangular or regular hexagonal shape. In addition, it is preferable that the cross-section of the core is at least 100 μm² in area.

The plastic optical member further comprises a protective coat on an outer periphery of the clad. It is preferable that the protective coat is formed by coating radiation-hardening resin and radiating for hardening the coating. Alternatively, it is preferable that the protective coat is formed by extrusion of thermoplastic resin.

According to the method for producing the plastic optical member of the present invention, since the cross-sectional shape of the preform is non-circular, and the preform is heat-drawn to form the plastic optical member having the cross-sectional shape similar to that of the preform, the plastic optical member having fine structure can be easily produced without use of a special device.

Since the preform is a preform piece assembly constituted by assembling plural preform pieces, the preform having complicated cross-sectional shape can be easily obtained. Therefore, the plastic optical member having complicated cross-sectional shape can be easily produced. Since the preform piece assembly includes at least one secondary preform piece formed by heat-drawing the primary preform piece, the plastic optical member having more complicated cross-sectional shape can be easily produced. In addition, since the preform piece assembly is constituted by assembling plural kinds of preform pieces having different shapes or optical properties, the plastic optical member having complicated internal structure can be easily produced.

Since the preform piece includes the core to be a light transmitting path and the clad having a refraction index rower than that of the core, an optical member such as a POF (plastic optical fiber), a plastic optical waveguide, a plastic optical transmission medium or the like can be easily produced. In addition, the plastic optical member having plural light transmitting path can be easily obtained from the preform assembly including the plural preform pieces having a core. Since the core is formed mainly from (meth) acrylic ester, and the clad mainly includes fluorine resin, the plastic optical member causing low transmission loss can be obtained.

### BRIEF DESCRIPTION OF DRAWINGS

FIG. 1 is a flow chart showing a first process for producing an optical member of the present invention;

FIG. 2 is an explanatory view showing a drawing process for producing the optical member;

FIG. 3 is a flow chart showing a second process for producing an optical member of the present invention;

FIG. 4 is a flow chart showing a third process for producing an optical member of the present invention;

FIG. 5 is a flow chart showing a fourth process for producing an optical member of the present invention;

FIG. 6 is a flow chart showing a fifth process for producing an optical member of the present invention;

FIG. 7 is a flow chart showing a sixth process for producing an optical member of the present invention;

FIG. 8 is a flow chart showing a seventh process for producing an optical member of the present invention;

FIG. 9A-C are schematic views showing an embodiment of the first process for producing an optical member;

FIG. 10A-C are schematic views showing an embodiment of the second process for producing an optical member;

FIG. 11A-E are schematic views showing an embodiment of the third process for producing an optical member;

FIG. 12A-C are schematic views showing another embodiment of the third process for producing an optical member;

FIG. 13A-C are schematic views showing another embodiment of the third process for producing an optical member;

FIG. 14A-C are schematic views showing another embodiment of the third process for producing an optical member;

FIG. 15A-C are schematic views showing another embodiment of the third process for producing an optical member;

FIG. 16A-C are schematic views showing another embodiment of the third process for producing an optical member;

FIG. 17A-C are schematic views showing another embodiment of the third process for producing an optical member;

FIG. 18A-C are schematic views showing another embodiment of the third process for producing an optical member;

FIG. 19A-C are schematic views showing an embodiment of the fourth process for producing an optical member;

FIG. 20A-C are schematic views showing another embodiment of the fourth process for producing an optical member;

FIG. 21A, B are schematic views showing an embodiment of the fifth process for producing an optical member;

FIG. 22 are schematic views showing another embodiment of the fifth process for producing an optical member;

FIG. 23A-E are schematic views showing an embodiment of the sixth process for producing an optical member;

FIG. 24A-E are schematic views showing another embodiment of the sixth process for producing an optical member;

FIG. 25A-C are schematic views showing another embodiment of the sixth process for producing an optical member;

FIG. 26A, B are schematic views showing another embodiment of the sixth process for producing an optical member.

### BEST MODE FOR CARRYING OUT THE INVENTION

The present invention is described in detail with reference to preferred embodiments. These embodiments described below do not limit the scope of the claims of the present invention.

(Core)

As a raw material of a core, it is preferable to select a polymerizable monomer that is easily bulk polymerized. Examples of the raw materials with high optical transmittance and easy bulk polymerization are (meth)acrylic acid esters [(a) (meth)acrylic ester without fluorine, (b) (meth)acrylic ester containing fluorine], (c) styrene type compounds, (d) vinyl esters, or the like. The core may be formed from homopolymer composed of one of these monomers, from copolymer composed of at least two kinds of these monomers, or from a mixture of the homopolymer(s) and/or the copolymer(s). Among them, (meth)acrylic acid ester can be used as a polymerizable monomer.

Concretely, examples of the (a) (meth)acrylic ester without fluorine as the polymerizable monomer are methyl methacrylate (MMA); ethyl methacrylate; isopropyl methacrylate; tert-butyl methacrylate; benzyl methacrylate (BzMA); phenyl methacrylate; cyclohexyl methacrylate, diphenylmethyl methacrylate; tricyclo [5.2.1.0^{2.6}] decanyl methacrylate; adamanthyl methacrylate; isobonyl methacrylate; norbornyl methacrylate; methyl acrylate; ethyl acrylate; tert-butyl acrylate; phenyl acrylate, and the like. Examples of (b) (meth)acrylic ester with fluorine are 2,2,2-trifluoroethyl methacrylate; 2,2,3,3-tetrafluoro propyl methacrylate; 2,2,3,3,3-pentafluoro propyl methacrylate; 1-trifluoromethyl-2,2,2-trifluoromethyl methacrylate; 2,2,3,3,4,4,5,5-octafluoropenthyl methacrylate; 2,2,3,3,4,4,-hexafluorobutyl methacrylate, and the like. Further, in (c) styrene type compounds, there are styrene; a-methylstyrene; chlorostyrene; bromostyrene and the like. In (d) vinylesters, there are vinylacetate; vinylbenzoate; vinylphenylacetate; vinylchloroacetate; and the like. The polymerzable monomers are not limited to the monomers listed above. Preferably, the kinds and composition of the monomers are selected such that the refractive index of the homopolymer or the copolymer in the core is approximately similar or higher than the refractive index in the clad. As the polymer for the raw material, polymethyl methacrylate (PMMA), which is a transparent resin, is more preferable.

When an optical member is used for near infrared ray, the C—H bond in the compound of the core causes absorption loss. By use of the polymer in which the hydrogen atom (H) of the C—H bond is substituted by the deuterium (D) or fluorine (F), the wavelength range to cause transmission loss shifts to a larger wavelength region. Japanese Patent No. 3332922 teaches the examples of such polymers, such as deuterated polymethylmethacrylate (PMMA-d8), polytrifluoroethylmethacrylate (P3FMA), polyhexafluoro isopropyl-2-fluoroacrylate (HFIP 2-FA), and the like. Thereby, it is possible to reduce the loss of transmission light. It is to be noted that the impurities and foreign materials in the monomers that causes dispersion should be sufficiently removed before polymerization so as to keep the transparency of the POF 17 after polymerization.

(Clad)

In order that the transmitted light in the core is completely reflected at the interface between the core and the clad, the material for the clad is required to have smaller refractive index than the core and exhibits excellent fitness to the core. If there is irregularity between the core and the clad, or if the material for the clad does not fit the core, at least one layer may be provided between the core and the clad. For example, an outer core layer, formed on the peripheral surface of the core (inner wall of the tubular clad pipe) from the same composition as the matrix of the core, can improve the interface condition between the core and the clad. The description of the outer core layer will be explained later. Instead of the outer core layer, the clad may be formed such that the matrix of the clad has the same composition as the matrix of the core.

A material having excellent toughness, moisture resistance and heat-resistance is preferable for the clad. For example, a homopolymer or a copolymer of the monomer including fluorine is preferable. As the monomer including fluorine, vinylidene fluoride (VDF) is preferable. It is also preferable to use a fluorine resin obtained by polymerizing one kind or more of polymerizable monomer having 10 wt % of vinylidene fluoride.

In the event of forming the clad of the polymer by melt-extrusion, the viscosity of the molten polymer needs to be appropriate. The viscosity of the molten polymer correlates the molecular weight, especially the weight-average molecular weight. In this preferable embodiment, the weight-average molecular weight is preferably 10,000 to 1,000,000, and more preferably 50,000 to 500,000.

It is also preferable to prevent the core from absorbing water. Thus, a polymer with low water absorption is used as the material for the clad. The clad may be formed from the polymer having the saturated water absorption (water absorption) of less than 1.8%. More preferably, the water absorption of the polymer is less than 1.5%, and most preferably less than 1.0%. The outer core layer is preferably formed from the polymer having approximately similar water absorption. The water absorption (%) is obtained by measuring the water absorption after soaking the sample of the polymer in the water of 23° C. for one week, pursuant to the American Society for Testing and Materials (ASTM) D 570.

(Polymerization Initiators)

In polymerizing the monomer to form the polymer as the core and the clad, polymerization initiators can be added to initiate polymerization of the monomers. The polymerization initiator to be added is appropriately chosen in accordance with the monomer and the method of polymerization. Examples of the polymerization initiators are peroxide compounds, such as benzoil peroxide (BPO); tert-butylperoxy-2-ethylhexanate (PBO); di-tert-butylperoxide (PBD); tert-butylperoxyisopropylcarbonate (PBI); n-butyl-4,4-bis(tert-butylperoxy)valarate (PHV), and the like. Other examples of the polymerization initiators are azo compounds, such as 2,2′-azobisisobutylonitril; 2,2′-azobis(2-methylbutylonitril); 1,1′-azobis(cyclohexane-1-carbonitryl); 2,2′-azobis(2-methylpropane); 2,2′-azobis(2-methylbutane) 2,2′-azobis(2-methylpentane); 2,2′-azobis(2,3-dimethylbutane); 2,2′-azobis(2-methylhexane); 2,2′-azobis(2,4-dimethylpentane); 2,2′-azobis (2,3,3-trimethylbutane); 2,2′-azobis(2,4,4-trimethylpentane); 3,3′-azobis(3-methylpentane); 3,3′-azobis(3-methylhexane); 3,3′-azobis(3,4-dimethypentane); 3,3′-azobis(3-ethylpentane); dimethyl-2,2′-azobis(2-methylpropionate); diethyl-2,2′-azobis(2-methylpropionate); di-tert-butyl-2,2′-azobis(2-methylpropionate), and the like. Note that the polymerization initiators are not limited to the above substances. More than one kind of the polymerization initiators may be combined.

(Chain Transfer Agent)

The polymerizable composition for the clad and the core preferably contain a chain transfer agent for mainly controlling the molecular weight of the polymer. The chain transfer agent can control the polymerization speed and polymerization degree in forming the polymer from the polymerizable monomer, and thus it is possible to control the molecular weight of the polymer. For instance, in drawing the preform to produce the optical member, adjusting the molecular weight by the chain transfer agent can control the mechanical properties of the optical member in the drawing process. Thus, adding the chain transfer agent makes it possible to increase the productivity of the optical member.

The kind and the amount of the chain transfer agent are selected in accordance with the kinds of the polymerizable monomer. The chain transfer coefficient of the chain transfer agent to the respective monomer is described, for example, in “Polymer Handbook, 3^{rd} edition”, (edited by J. BRANDRUP & E. H. IMMERGUT, issued from JOHN WILEY&SON). In addition, the chain transfer coefficient may be calculated through the experiments in the method described in “Experiment Method of Polymers” (edited by Takayuki Ohtsu and Masayoshi Kinoshita, issued from Kagakudojin, 1972).

Preferable examples of the chain transfer agent are alkylmercaptans [for instance, n-butylmercaptan; n-pentylmercaptan; n-octylmercaptan; n-laurylmercaptan; tert-dodecylmercaptan, and the like], and thiophenols [for example, thiophenol; m-bromothiophenol; p-bromothiophenol; m-toluenethiol; p-toluenethiol, and the like]. It is especially preferable to use n-octylmercaptan, n-laurylmercaptan, and tert-dodecylmercaptan in the alkylmercaptans. Further, the hydrogen atom on C—H bond may be substituted by the fluorine atom (F) or a deuterium atom (D) in the chain transfer agent. Note that the chain transfer agents are not limited to the above substances. More than one kind of the chain transfer agents may be combined.

(Refractive Index Control Agent)

The refractive index control agent may be preferably added to the polymerizable composition for the core. It is also possible to add the refractive index control agent to the polymerizable composition for the clad. The core having refractive index profile can be easily formed by providing the concentration distribution of the refractive index control agent. Without the refractive index control agent, it is possible to form the core having refractive index profile by providing the profile in the co-polymerization ratio of more than one kind of the polymerizable monomers in the core. However, in consideration of controlling the composition of the copolymer, adding the refractive index control agent is preferable.

The refractive index control agent is referred to as “dopant”. The dopant is a compound that has different refractive index from the polymerizable monomer to be combined. The difference in the refractive index between the dopant and the polymerizable monomer is preferably 0.005 or more. The dopant has the feature to increase the refractive index of the polymer, compared to one that does not include the dopant. In comparison of the polymers produced from the monomers as described in Japanese Patent Publication No. 3332922 and Japanese Patent Laid-Open Publication No. 5-173026, the dopant has the feature that the difference in solution parameter is 7 (cal/cm³)^{1/2} or smaller, and the difference in the refractive index is 0.001 or higher. Any materials having such features may be used as the dopant if such material can change the refractive index and stably exists with the polymers, and the material is stable under the polymerizing condition (such as temperature and pressure conditions) of the polymerizable monomers as described above.

This embodiment shows the method to form a refractive index profile in the core by controlling the direction of polymerization by interface gel polymerizing method, and by providing concentration gradation of the refractive index control agent as the dopant during the process to form the core from the polymerizable composition mixed with the dopant. As the refractive index profile, there are the graded index (GI) type having the continuous graded index distribution, in which the refractive index gradually decreases from the center to the periphery of the core, and the multi-step index (MSI) type having the stepwise refractive index distribution, in which the refractive index gradually decreases from the center to the periphery of the core in a step-wise. These types of optical members have a wide range of transmission band.

The dopant may be polymerizable compound, and in that case, it is preferable that the copolymer having the dopant as copolymerized component increases the refractive index in comparison of the polymer without the dopant. An example of such copolymer is MMA-BZMA copolymer.

As described in Japanese Patent Publication No. 3332922 and Japanese Patent Laid-Open Publication No. 11-142657, examples of the dopants are benzyl benzoate (BEN); diphenyl sulfide (DPS); triphenyl phosphate (TPP); benzyl n-butyl phthalate (BBP); diphenyl phthalate (DPP); diphenyl (DP); diphenylmethane (DPM); tricresyl phosphate (TCP); diphenylsoufoxide (DPSO); diphenyl sulfide derivative; dithiane derivative. Among them, BEN, DPS, TPP, DPSO, diphenyl sulfide derivative and dithiane derivative are preferable. In order to improve the transparency in a longer wavelength range, it is possible to use the compounds in which the hydrogen atom is substituted by the deuterium. Example of the polymerizable compound is tribromophenyl methacrylate. A polymerizable compound as the dopant is advantageous in heat resistance although it would be difficult to control various properties (especially optical property) because of copolymerization of polymerizable monomer and polymerizable dopant.

It is possible to control the refractive index of the optical member by controlling the density and distribution of the refractive index control agent to be mixed with the core. The amount of the refractive index control agent may be appropriately chosen in accordance with the purpose of the optical member. More than one kind of the refractive index control agents can be added.

(Other Additives)

Other additives may be contained in the core and the clad so far as the transmittance properties do not decrease. For example, the additives may be used for increasing resistance of climate and durability. Further, induced emissive functional compounds may be added for amplifying the optical signal. When such compounds are added to the monomers, weak signal light is amplified by excitation light so that the transmission distance increases. Therefore, the optical member with such additive may be used as an optical fiber amplifier. These additives may be contained in the core and/or the clad by polymerizing the additives with the monomers.

(Coating Material)

After a heat-drawing, it is preferable that a coating layer (protective coat) is provided on the outer periphery of the clad, by extrusion of molten resin or the like. Although the material for the coating layer is not limited, thermoplastic resins are preferably used. Especially, polyolefin resins are preferably used for their superior chemical resistance and flexibility. As the polyolefin resin, for example there is polymer from ethylene, propylene or α-olefin. As the α-olefin, for example there is 1-butene, 1-pentene, 1-hexene, 4-methyl-1-pentene, 1-peptene or 1-octene. And as their polymers, for example there are polyethylene, copolymer of ethylene and propylene, copolymer of ethylene and α-olefin, polypropylene, copolymer of propylene and α-olefin, polybutene, polyisoprene and the like. In addition, the polyolefin resins can be blended to obtain desired properties. Note that although molecular weight and molecular weight distribution of the polyolefin resin are not limited, a weight-average molecular weight is normally in a range of 5000 to 5000000, preferably in a range of 20000 to 300000. In addition, a molecular weight distribution, which is calculated by dividing weight-average molecular weight (Mw) by number average molecular weight (Mn), is in a range of 2 to 80, preferably in a range of 3 to 40.

The coating material can be also formed by radiating on radiation-hardening resin coating or heating on heat-hardening resin coating. As the radiation-hardening resin, for example there is acrylic-modified unsaturated polyester or epoxy resin, or polyurethane. As the heat-hardening resin, for example there is phenol resin, melamine resin or diacryl phthalate. In addition, a plurality of the coating layer can be formed. When the plural layers are formed, a tensile strength fiber or the like may be provided between the layers.

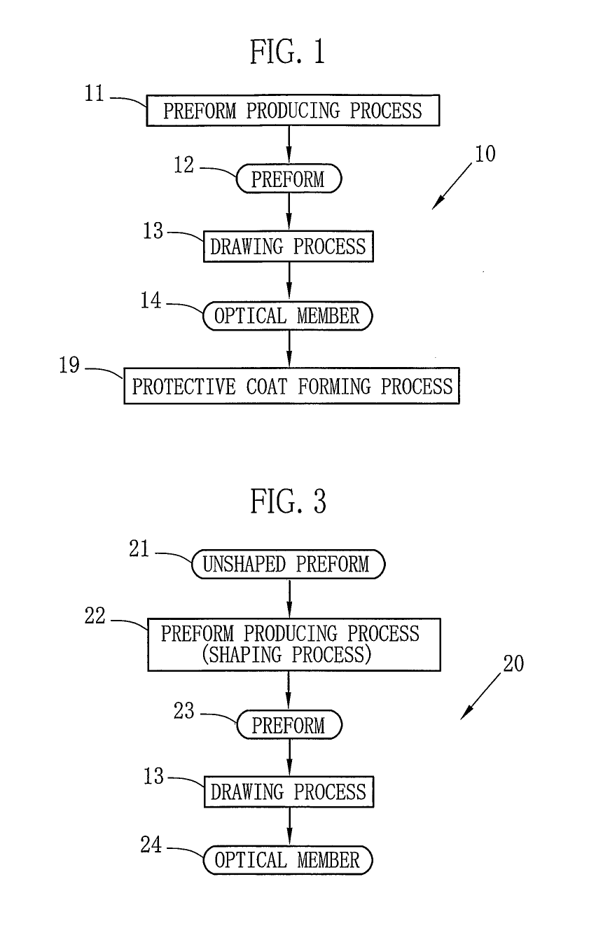

In a first process 10 shown in FIG. 1, a perform 12 is produced by a preform producing process 11. The preform 12 has the core and the clad. The core is for transmitting incoming light, and the clad has the refractive index lower than that of the core. Although the producing method for the perform 12 is not limited, one preferable method is the melt-extrusion. A melt-extrusion device used for the melt-extrusion has a multi-spinning nozzle on a tip thereof. Configurations of a nipple and a die of the multi-spinning nozzle are not limited. The preform 12 is obtained by simultaneously extruding the clad and the core from the multi-spinning nozzle. According to the configurations of the nipple and the die, a cross-section of the preform 12 can become noncircular shape. The preform 12 can be produced also by injection molding. The shape of the cross-section of the perform 12 is a polygon, a closed curve, or a combination of line and curve. For example, there are an ellipse, a rectangle, a combination of line and a circular curve and an ellipse.

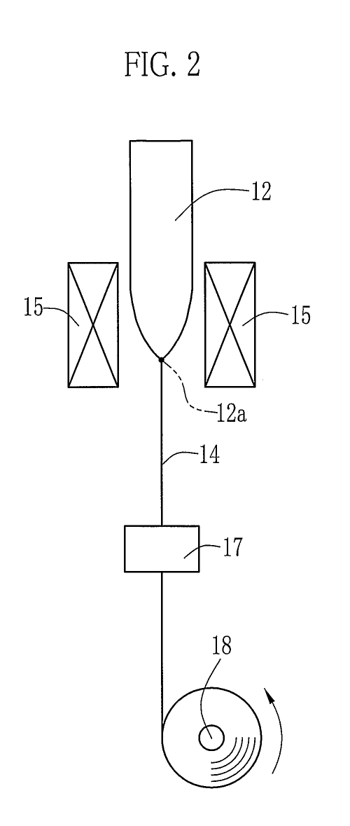

In a drawing process 13, the preform 12 is heated by a heating furnace 15, as shown in FIG. 2. A part of the preform 12 is soften by the heating. Although a softening temperature is not limited, it is preferably in a range of 80° C. to 500° C., particularly in a range of 180° C. to 240° C., especially in a range of 190° C. to 220° C. The drawing is started from an end 12a of the soften part, to obtain an optical member 14. Then the optical member 14 is wound into a roll shape around a winding shaft 18 of a winding device (not shown). While the drawing, the diameter monitor 17 monitors the diameter of the optical member 14, to adjust the position of the preform 12 in relation to the heating furnace 15, the temperature of the heating furnace 15, the winding speed of the winding device and so on. Accordingly, the optical member 14 having constant diameter can be obtained.

In the heat-drawing in the present invention, when the preform having noncircular cross-sectional shape is “soften”, the optical member having a approximately similar cross-sectional shape is obtained. And in the heat-drawing in the present invention, when the preform having noncircular cross-sectional shape is “melt”, the optical member having a cross-sectional shape not similar to that of the preform, such as circular shape, is obtained. Since the temperature for soften the preform depends on a temperature characteristic of the polymer, the heat-drawing is performed in a specific temperature range for softening the polymer, which is obtained by experiments or the like. In particular, a temperature when a melt viscosity becomes 1.0×10⁴ Pa·s is determined as a softening temperature Ts. The melt viscosity is measured by warming 5.0° C./min and pressurizing a sample.

According to the softening, the optical member 14 having a cross-sectional shape approximately similar to that of the preform 12 is obtained. If the part of the preform 12 is soften in a continuous fashion to obtain the optical member 14, a production cost can be reduced. The optical member 14 may be coated with resin by a protective coat forming process 19 (see FIG. 1), to protect the outer periphery thereof. The protective coat is formed by coating the radiation-hardening resin and radiating for hardening the coat. The protective coat may be formed also by extrusion of the thermoplastic resin. As the optical member 14 produced by this producing method, there are a rectangular POF, an optical transmission medium and the like. Note that the protective coat forming process 19 may be performed whether in the production line for the optical member after the drawing process, or in another production line.

In a second process 20 shown in FIG. 3, at first an unshaped preform 21 is produced. The unshaped preform 21 has the core and the clad. The core is a transmitting path for incoming light, and the clad covers the core such that the transmitting light is totally reflected at an interface between the core and the clad. The unshaped preform 21 is produced by the melt-extrusion by using the multi-spinning nozzle as same as the first process 10, for example. The unshaped preform 21, which has a circular or approximately circular cross-sectional shape, is shaped into a preform 23 having a desired cross-sectional shape by a preform producing process (shaping process) 22. In the shaping process, the unshaped preform 21 is pressed or heat-pressed for deformation. As an optical member 14 produced by this producing method, there is a taped shape of POF.

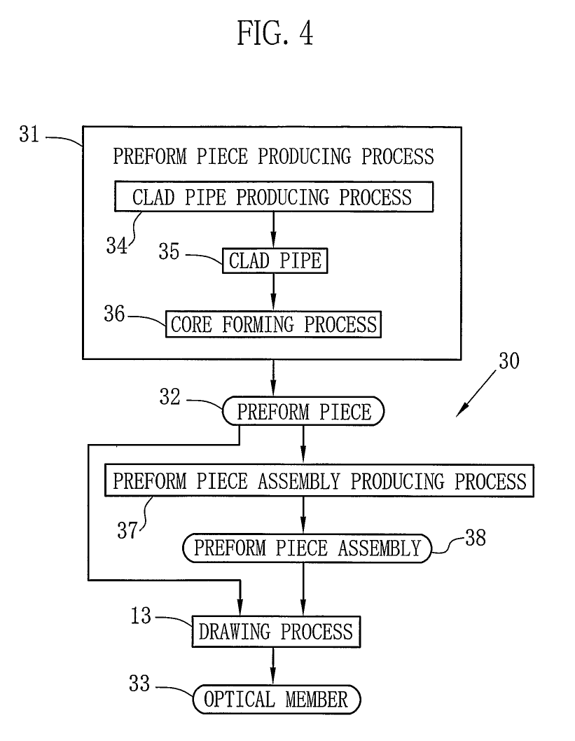

In a third process 30 shown in FIG. 4, at first a preform piece 32 is produced by a preform piece producing process 31. Next, the preform piece 32 is applied the heat soften-drawing by the drawing process 13, to obtain the optical member 33. In the preform piece producing process 31, at first a clad pipe 35 is produced by a clad pipe producing process 34. The producing method for the clad pipe is not limited. For example, a rotate-polymerization method is applied to obtain the clad pipe 35, in this method the polymerizable monomers (for example MMA), the polymerization initiators and other additives are putted in a rigid glass tube to start the polymerization, and the glass tube is rotated with its longitudinal direction being in horizontal. Note that the clad pipe 35 may be also produced by the melt-extrusion or the injection molding. Although the material of the clad pipe 35 is not limited, acrylic resin such as PMMA or fluorine resin such as PVDF is preferably used. Note that a cross-sectional shape of the clad pipe 35 may be a polygon (such as a triangle, a rectangle, a pentagon and a hexagon), an ellipse, a combination of line and a curve or a circular arc.

Next, a core forming process 36, for forming the GI type core when PVDF is used as the material of the clad pipe 35, is described. At first, an outer core layer, which becomes an interface for the interfacial gel polymerization, is formed. To form the outer core layer, MMA as the polymerizable monomers and other additives (for example the polymerization initiators) is putted in the clad pipe 35 of PVDF. Then the rotate-polymerization is performed such that the clad pipe 35 is rotated with its longitudinal direction being in horizontal. By this rotate-polymerization, the MMA polymerizes to be PMMA. For becoming the interface for the interfacial gel polymerization, the thickness of the outer core layer is preferably in a range of 1 mm to 5 mm.

Next, additives, such as MMA as the polymerizable monomers, low molecular weight compound with high refractive index as the refractive index control agent, the polymerization initiators, are putted in the clad pipe with the outer core layer being formed. Then the polymerization is started to form the GI type core, in which the refractive index gradually increases in an approximately square distribution from the outer periphery to the center of the core. The obtained preform piece 32 is applied the heat soften-drawing by the drawing process 13, to obtain the optical member 33. The cross-sectional shape of the optical member 33 is approximately similar to that of the preform piece 32. Accordingly, the optical member 33 has the core of the PMMA basis and the clad of the PVDF basis. As the optical member 33 produced by this producing method, there is a POF for high-speed communication.

Next, a producing method for the optical member 33 having plural light transmitting paths is described. The plural preform pieces 32 are produced by the preform piece producing process 31. The plural preform pieces 32 constitute a preform piece assembly 38. Note that the single preform piece 32 can constitute the preform. Although a number of the perform piece 32 in the preform piece assembly 38 is not limited, the number is preferably in a range of 2 to 100, particularly in a range of 2 to 50, especially in a range of 2 to 10. Note that the preform piece can be produced by the same process as the preform producing process 11 or 22.

The preform pieces 32 are joined together with others by welding or adhesion, to be assembled. Note that the welding or adhesion may be performed whether before the heat-drawing or by heat of the heat-drawing, as described later. The preform piece assembly 38 may be coated by a coating. In the preform piece assembly producing process 37, the plural preform pieces 32 are bundled by adhesive (such as urethane compounds, epoxy compounds, acrylic compounds or the like), to become the preform piece assembly 38. Alternatively, heat-press method, ultrasonic welding method, vibration welding method or the like may be used for the assembling.

Next, the heat-drawing is applied to the preform piece assembly 38 in the drawing process 13, to obtain the optical member 33. In the heat-drawing, the heating condition is controlled so that the optical member 33 having the cross-sectional shape approximately similar to that of the preform piece assembly 38 is obtained. Note that the cross-sectional shape of the preform piece assembly 38 is not limited, and may be a circle, an ellipse, a polygon, a combination of line and a curve. As the optical member 33 produced by this producing method, there are POF having two cores for high-speed serial transmission, POF having plural cores for parallel transmission, POF for image reading and a plastic optical fiber array.

Note that in the preform piece assembly producing process 37, the drawing can be performed when the plural preform pieces 32 are aligned but not adhered. In this case, when the plural preform pieces are soften by heat in the drawing process, the surfaces of the preform pieces are adhered to others. Therefore, the optical member 33 having the cross-sectional shape approximately similar to that of the preform piece assembly 38 can be obtained. This method is preferably applied when the number of the preform pieces is small, and has an advantage of omitting the bonding process. Note that the cross-sectional shape of the preform piece assembly 38 is not limited, and may be a circle, an ellipse, a polygon, a combination of line and a curve. As the optical member 33 produced by this producing method, there are POF having two cores for high-speed serial transmission, POF having plural cores for parallel transmission, POF for image reading and a plastic optical fiber array.

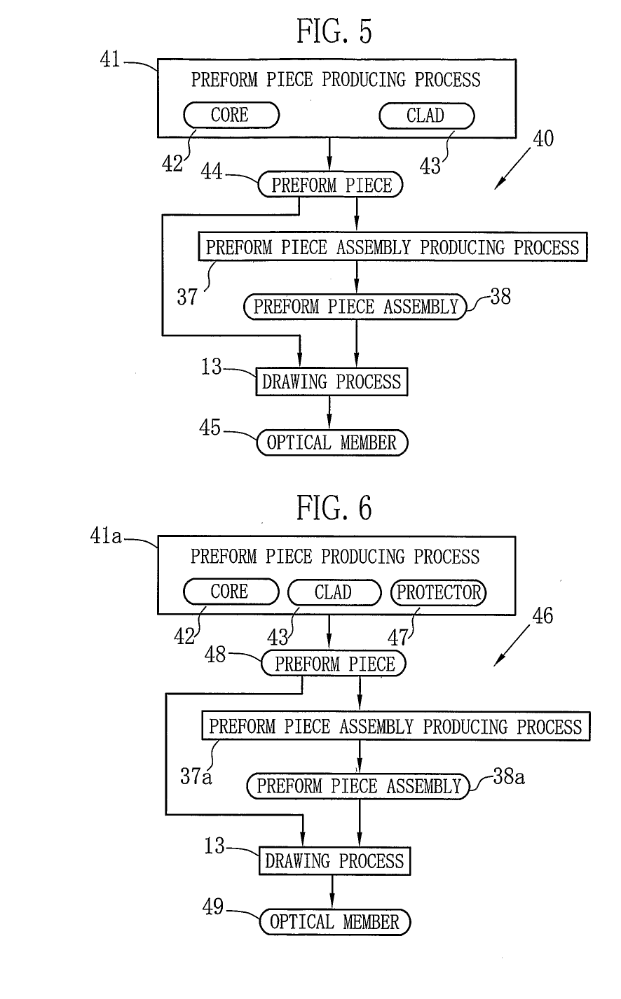

Only a difference between a fourth process 40 shown in FIG. 5 and the third process is that a core 42 and a clad 43 are separately formed in a preform piece producing process 41. A method for producing the core and clad is not limited, for example there are the rotate-polymerization method for polymerizing polymerizable monomers, the melt-extrusion method and the injection molding method. The clad 43 is positioned on an outer periphery of the core 42. Note that plural cores may be produced, and each of the cores 42 is covered by the clad 43 in this case. An obtained preform piece 44 is drawn in the drawing process 13, to obtain an optical member 45. When preform piece 44 is produced, it does not matter whether the core 42 and the clad 43 are adhered by adhesive, or not adhered. In the case that the preform piece 44 is formed without using the adhesive, the core and the clad closely contact each other when they are soften by heat in the drawing process 13, to be the optical member 45. As the optical member 45 produced by this producing method, there are light transmission materials having single core or plural cores.

Only a difference between a fifth process 46 shown in FIG. 6 and the fourth process 40 is that the core 42, the clad 43 and a protector 47 are separately formed in a preform piece producing process 41a. The protector 47 is formed by the melt-extrusion method, the injection molding method or the like. The protector 47 covers the clad 43. Note that a plurality of the cores 42, clads 43 and protectors 47 may be produced. An obtained preform piece assembly 38a is drawn in the drawing process 13, to obtain an optical member 49. As the optical member 49 produced by this producing method, there are light transmission materials having single core or plural cores.

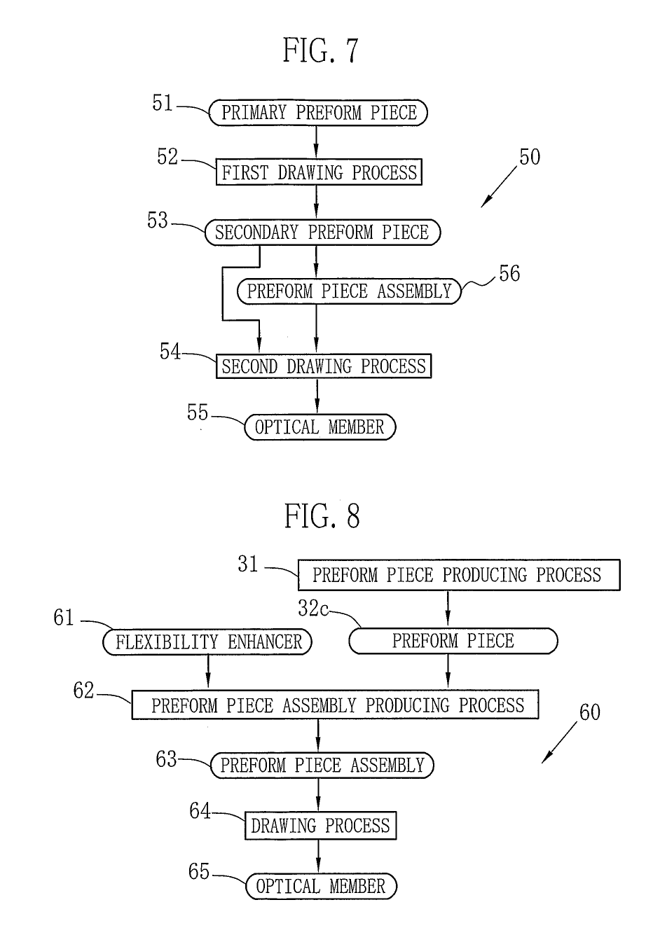

In a sixth process 50 shown in FIG. 7, a primary preform piece 51 having a core and a clad is heat-soften-drawn in a first drawing process 52, to obtain a secondary preform piece 53. A heating temperature in the first drawing process 52 is not limited. For drawing the primary preform piece 51 having the core of PMMA and the clad of PVDF, the heating temperature is preferably in a range of 80° C. to 500° C. Although a drawing ratio in the first drawing process 52 is also not limited, it is preferable in a range of 10 to 500. Then the secondary preform piece 53 is heat-soften-drawn in a second drawing process 54, to obtain an optical member 55. Although a heating temperature in the second drawing process 54 is not limited, it is preferably in a range of 80° C. to 500° C. Although a drawing ratio in the second drawing process 54 is also not limited, it is preferable in a range of 10 to 5000. It may be also that plural secondary preform piece 53 forms a preform piece assembly 56 and then the preform piece assembly 56 is heat-drawn in the second drawing process 54 to obtain the optical member 55. As the optical member 55 produced by this producing method, there are an optical waveguide having plural cores for parallel transmission and a plastic optical fiber array for image reading. Note that although the first preform piece 52 is drawn once by the drawing process 52 to obtain the second preform piece 53, the drawing may be performed more than once.

A concrete example of the sixth process 50 for producing the optical member 55 is now explained. MMA as the polymerizable monomers, low molecular weight compound with high refractive index as the refractive index control agent (dopant), and desired additives (such as the polymerization initiators), are putted in the clad pipe of PMMA. Then the rotate-polymerization is performed such that the clad pipe is rotated with its longitudinal direction being in horizontal. By this rotate-polymerization, the MMA polymerizes to be the polymer of the core. The primary preform piece 51 produced by this process has cylindrical shape with a hollow center.

The primary preform piece 51 is heat-drawn in the first drawing process 52, with the hollow center being closed. In the first drawing process 52, the temperature for the heat-drawing is controlled in close to the softening temperature of the polymer, for the cross-section of the primary preform piece 51 not being largely deformed. Then the obtained secondary preform piece 53 is heat-drawn in the second drawing process 54, to obtain the desired optical member 55. By cutting the optical member 55 in a desired length, for example a plastic lens having refractive index profile is obtained.

In a seventh process 60 shown in FIG. 8, a plurality of preform pieces 32c are produced in the preform piece producing process 31. Although the number of the preform pieces 32c is not limited, it is preferably in a range of 2 to 100, particularly in a range of 2 to 50, especially in a range of 2 to 10. Note that the preform piece can be produced by the same process as the preform producing process 11 or 22.

In a preform piece assembly producing process 62, the plural preform pieces 32c and flexibility enhancer 61 form a preform piece assembly 63. The flexibility enhancer 61 is formed for example such that short fiber of tensile strength fiber such as aramid fiber is dispersed in thermoplastic resin. In the preform piece assembly producing process 62, the plural preform pieces 32c and the flexibility enhancer 61 are bundled by adhesive (such as urethane compounds, epoxy compounds, acrylic compounds or the like), to become the preform piece assembly 63. In a drawing process 64, the heat-drawing is performed so that the optical member 65 having the cross-sectional shape approximately similar to that of the preform piece assembly 63 is obtained. Note that the cross-sectional shape of the preform piece assembly 63 is not limited, and may be a circle, an ellipse, a polygon, a combination of line and a curve. As the optical member 65 produced by this producing method, there are an optical waveguide having plural cores for parallel transmission and a plastic optical fiber array for image reading.

Note that in the preform piece assembly producing process 62, the plural preform pieces 32c and the flexibility enhancer 61 may be bundled without using adhesive. For example, these may be bundled by heat-welding with preventing a change of their properties, or by pressure bonding.

Instead of using adhesive for adhering the plural preform pieces 32c to form the preform piece assembly 63, the heat-press method, the ultrasonic welding method, the vibration welding method or the like may be used. The cross-sectional shape of the preform piece assembly 63 is not limited, and may be a circle, an ellipse, a polygon, a combination of line and a curve. In addition, material and structure of the flexibility enhancer 61 are not limited. However, as the material of the flexibility enhancer 61, elastomer or the like is preferable for adhering to the preform piece 32c and being drawn. When the optical member 65 is used as the optical transmission medium and there is possibility to generate crosstalk because of leaking light from the clad, a structure for preventing the crosstalk is needed. In this case, light-shielding material is used for the clad or the outer periphery of the clad. Alternatively, thermoplastic material including light-shielding member is putted between each of the optical transmission mediums, and is drawn to form a layer including the light-shielding member between the optical transmission mediums. The light-shielding member is formed by use of colored particles or dye. As the colored particle, carbon black is preferably used.

When the intensity of the leaking light is not high, light scattering members may be used for reducing the power of the noise light. The light scattering member less deteriorates S/N ratio than the light-shielding member. As the optical member 65 produced in this method, there is light transmission material having plural cores, which is used for moving part or under hard vibration.

In the each embodiment, light scattering particles may be preliminarily contained in the core. Although size of the light scattering particle is not limited, average diameter of the particles is preferably in a range of 1 μm to 2 μm. Although the material of the particle is not limited, silicone particle, silica particle, polystyrene particle, zirconia bead, melamine particle and the like are preferably used, particularly the silicone particle is used. By the core 42 containing the light scattering particle, the optical member of the present invention can be used for optical interconnection technique such as optical bus (sheet bus) disclosed in Japanese Patent Laid-Open Publication No. 10-186184, and for light guide members (such as a light guide plate, light diffusing sheet, light reflector and the like) in which the light scattering property is partly modified by a pattern of concentration of the light scattering particles.

The light transmission materials of the present invention is used for optical signal processing devices including optical components, such as a light emitting element, a light receiving element, an optical switch, an optical isolator, an optical integrated circuit, an optical transmitter and receiver module, and the like. Such materials may be combined with other silica or plastic optical fibers or optical waveguides. Any known techniques can be applied to the present invention. The techniques are described in, for example, “‘Basic and Practice of Plastic Optical Fiber’ (issued from NTS Inc.)”, “‘Optical members can be Loaded on Printed Wiring Assembly, at Last’ in Nikkei Electronics, vol. Dec. 3, 2001”, pp. 110-127”, and so on. By combining the optical member according to with the techniques in these publications, the optical member is applicable to wiring in apparatuses (such as computers and several digital apparatuses), wiring in trains and vessels, optical transmission system. The optical transmission system is suitable for high-speed and large capacity data communication and for control under no influence of electromagnetic wave, and particularly for short-distance use. As concrete examples of the optical transmission system, there are optical linking between an optical terminal and a digital device and between digital devices, indoor optical LAN in houses, collective housings, factories, offices, hospitals, schools, and outdoor optical LAN.

Further, other techniques to be combined with the optical transmission system are disclosed, for example, in “‘High-Uniformity Star Coupler Using Diffused Light Transmission’ in IEICE TRANS. ELECTRON., VOL. E84-C, No. 3, MARCH 2001, pp. 339-344”, “‘Interconnection in Technique of Optical Sheet bus’ in Journal of Japan Institute of Electronics Packaging., Vol. 3, No. 6, 2000, pp. 476-480”. Moreover, there are am optical bus (disclosed in Japanese Patent Laid-Open Publications No. 10-123350, No. 2002-90571, No. 2001-290055 and the like); an optical branching/coupling device (disclosed in Japanese Patent Laid-Open Publications No. 2001-74971, No. 2000-329962, No. 2001-74966, No. 2001-74968, No. 2001-318263, No. 2001-311840 and the like); an optical star coupler (disclosed in Japanese Patent Laid-Open Publications No. 2000-2416-55); an optical signal transmission device and an optical data bus system (disclosed in Japanese Patent Laid-Open Publications. No. 2002-62457, No. 2002-101044, No. 2001-305395 and the like); a processing device of optical signal (disclosed in Japanese Patent Laid-Open Publications No. 2000-23011 and the like); a cross connect system for optical signals (disclosed in Japanese Patent Laid-Open Publications No. 2001-86537 and the like); a light transmitting system (disclosed in Japanese Patent Laid-Open Publications No. 2002-26815 and the like); multi-function system (disclosed in Japanese Patent Laid-Open Publications No. 2001-339554, No. 2001-339555 and the like); and various kinds of optical waveguides, optical branching, optical couplers, optical multiplexers, optical demultiplexers and the like. When the optical system having the optical member according to the present invention is combined with these techniques, it is possible to construct an advanced optical transmission system to send/receive multiplexed optical signals. The plastic optical member according to the present invention is also applicable to other purposes, such as for lighting, energy transmission, illumination, and sensors.

The present invention will be described in detail with reference to Experiments (1)-(20) as the embodiments of the present invention. The materials, contents, operations and the like will be changed so far as these modifications are within the spirit of the present invention. Thus, the scope of the present invention is not limited to the Experiments described below.

(Experiment 1)

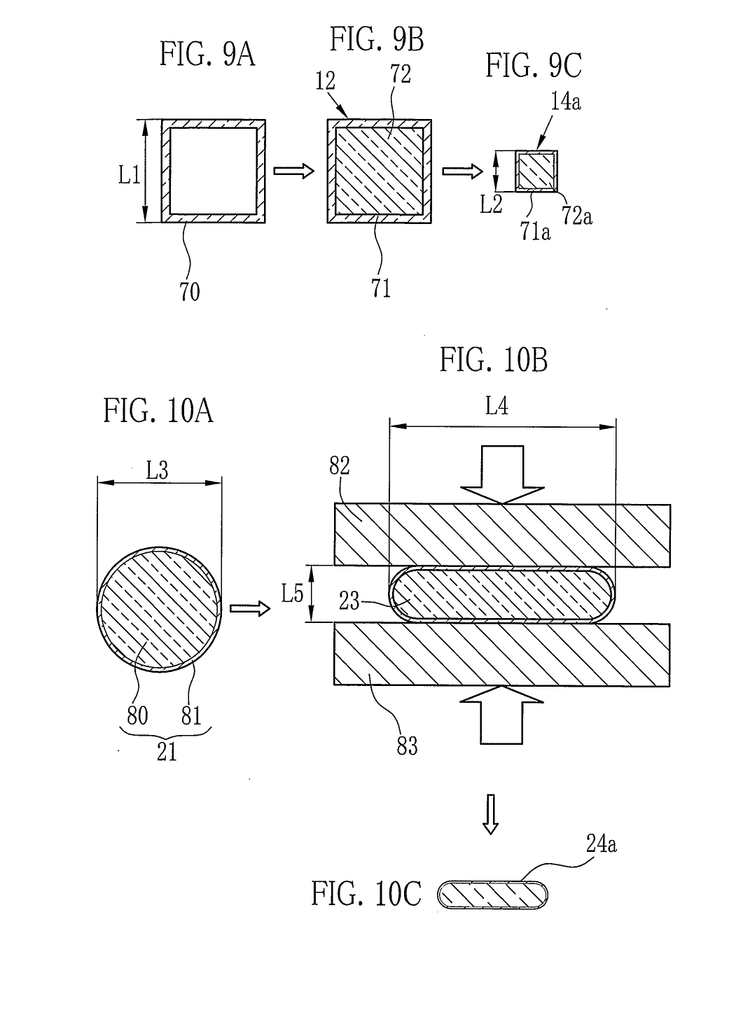

In experiment 1, an optical member 14a shown in FIG. 9C was obtained from preform 12 shown in FIG. 9B, by the first process 10 shown in FIG. 1. At first, as shown in FIG. 9A, a square pipe (hereinafter the clad pipe) 70 of 1000 mm length, which has 0.5 mm thickness and a cross-section whose sides L1 are 20 mm length, was provided. The clad pipe 70 became a clad 71a when the optical member 14a was obtained, for keeping transmitting light in a core 72a. The clad pipe 70 was formed of PVDF which is plastic having low refraction index. Note that in this experiment, the clad pipe 70 was formed by the melt-extrusion method.

Next, in the clad pipe 70, a core 72 was formed as shown in FIG. 9B. Although material of the core 72 is not limited while having optical transparency, it is preferable that optical transmission loss is low. In this experiment, PMMA which is (meth)acrylic acid resin was used. To form the core 72, methyl methacrylate (MMA) or the like was putted in the clad pipe 70 and was polymerized to be PMMA. The core 72 is a step index (SI) type, in which refraction index is approximately constant from the center to the outer periphery thereof. The preform 12 including the clad 71 and the core 72 was heat-drawn in the drawing process 13 shown in FIG. 1, in the temperature range of the softening point to the melting point. In this embodiment, the heating temperature was approximately 210° C. As a result, the optical member 14a which is a linear plastic optical transmission medium having a square cross-section, whose sides L2 are 0.5 mm length, was obtained as shown in FIG. 9C. In this experiment, the drawing ratio was 1600, and the length of the obtained optical member 14a was 1600 m at maximum.

(Experiment 2)

In experiment 2, an optical bus (sheet bus) which is the optical member 24 was produced by the second process 20 shown in FIG. 3. At first, as shown in FIG. 10A, a cylindrical unshaped preform 21, whose cross-section has the diameter L3 of 20 mm, was produced. The unshaped preform 21 comprises a core 80 and a clad 81. The clad 81 contains light scattering particles (silicon particles, whose average diameter is 1 μm). The core 80 mainly contains PMMA, and the clad 81 mainly contains PVDF. Next, as shown in FIG. 10B, the unshaped preform 21 was sandwiched between two flat plates 82 and 83, and was applied the heat-pressing process to be deformed, in 600 seconds at approximately 200° C. under approximately 0.5 MPa. As a result, the oval preform 23, whose cross-sectional ratio (L5:L4) is 1:4 (9.1 mm×36.4 mm) was obtained. Then in the drawing process 13 shown in FIG. 3, The preform 23 was heat-drawn in the temperature range of the softening point to the melting point. In this embodiment, the heating temperature was approximately 210° C. As a result, the optical member 24a, which is a linear plastic optical transmission medium having an oval cross-section of 0.5 mm×2.0 mm, was obtained as shown in FIG. 10C. In this experiment, the drawing ratio was 1600. The optical member 24a was able to be used as the optical bus for dividing optical signals, such that the optical signals entered into one end of the optical member 24a, and the optical signals were received at plural light receiving elements connected to the other end of the optical member 24a.

(Experiment 3)

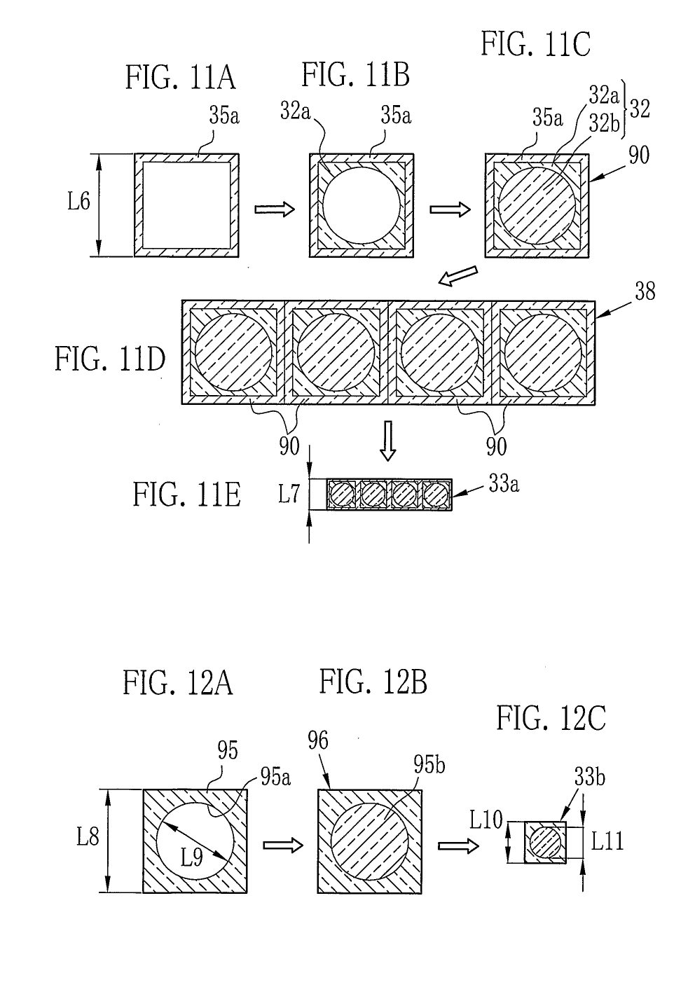

In experiment 3, an optical member 33a having four cores whose cross-section is square, as shown in FIG. 11E, was obtained by the third process 30 shown in FIG. 4. At first, in the clad pipe producing process 34 in the preform piece producing process 31, a square clad pipe 35a of PVDF, which has 1000 mm length, 0.5 mm thickness and a cross-section whose sides L6 are 10 mm length, was produced by the melt-extrusion. The clad pipe 35a was inserted in the polymerization container. After the polymerization container containing the clad pipe 12 was washed with pure water, the polymerization container was dried under the temperature of 90° C. Thereafter, one end of the clad pipe 35a was sealed by a Teflon (Registered Trademark) stopper. The inner wall of the clad pipe 35a was washed with ethanol, and then the clad pipe 35a was subject to decompression process (−0.08 MPa to atmospheric pressure) for 12 hours at 80° C. by an oven.

Next, an outer core polymerization process, which is in the core forming process 36 shown in FIG. 4, was carried out. The outer core liquid was prepared in an Erlenmeyer flask. The outer core liquid contains deuterated methylmethacrylate (MMA-d8, produced by Wako Pure Chemical Industries, Ltd.) of 205.0 g, 2-2′-azobis(isobutyric acid) dimethyl of 0.0512 g, and 1-dodecanethiol(laurylmercaptan) of 0.766 g. The outer core liquid was subject to ultrasonic irradiation for ten minutes by use of an ultrasonic cleaner USK-3 (38000 MHz, output power of 360 W), manufactured by AS ONE Corporation. Then, after pouring the outer core liquid in the clad pipe 35a, the clad pipe 35a was subject to decompression of 0.01 MPa to atmospheric pressure by use of a decompression filter machine, and subject to the ultrasonic process for 5 minutes by use of the ultrasonic cleaner.

After substituting the air in the tip of the clad pipe 35a with argon gas, the tip of the clad pipe was tightly sealed with a silicon stopper and a sealing tape. The clad pipe 35a containing the outer core liquid was subject to preliminary polymerization for two hours while the clad pipe 35a being vibrated in a hot water bath at 60° C. After the preliminary polymerization, the clad pipe 35a was held horizontally (the longitudinal direction of the clad pipe is kept horizontally) and was subject to heat polymerization (rotational polymerization) for 2 hours while rotating the clad pipe 35a at 500 rpm and keeping the temperature at 60° C. Thereafter, the clad pipe 12 was subject to rotational polymerization for 16 hours at 3000 rpm and 60° C., and then for 4 hours at 3000 rpm and 90° C. Thereby, an outer core 32a of PMMA-d8 (3 mm of average thickness), which is a square pipe with a circular hole, was formed inside the clad pipe 35a, as shown in FIG. 11B.

A preliminary process for forming the inner core was carried out. The clad pipe 35a was subject to decompression process (−0.08 MPa to atmospheric pressure) at 90° C. for 3 hours by an oven. Then, an inner core polymerization process was carried out. Inner core liquid, containing deuteriated methylmethacrylate (MMA-d8, produced by Wako Pure Chemical Industries, Ltd.) of 82.0 g, 2-2′-azobis(isobutyric acid) dimethyl of 0.070 g, 1-dodecanethiol(laurylmercaptan) of 0.306 g, and diphenyl sulfide (DPS) as the dopant of 6.00 g, was prepared in an Erlenmeyer flask. Then, the clad pipe 35a was subject to ultrasonic process irradiation for 10 minutes by use of the ultrasonic cleaner USK-3.

After keeping the inner core liquid for 20 minutes at 80° C., it was poured in the circular hole of the outer core 32a. One end of the circular hole was sealed with a Teflon (Registered Trademark) stopper. The clad pipe 35a was subject to interfacial gel polymerization in an autoclave for 24 hours at the temperature of 100° C. Then, the clad pipe 35a was subject to heat polymerization and heat process for 48 hours at 120° C. Thereby, the preform piece 90 having the inner core 32b was produced.

The preform piece 90 has a cross-section whose sides L6 are 10 mm length. In center of the preform piece 90 is the core 32, and the clad pipe 35a is around the core 32. Then the four preform pieces 90 were arranged in a line as one set to produce the preform piece assembly 38 as shown in FIG. 11D. The preform piece assembly 38 was heat-drawn in the temperature range of the softening point to the melting point. In this embodiment, the heating temperature was approximately 210° C. The preform piece assembly 38 is not required to fix by adhesive or the like, because it is welded by heat of the heat-drawing. Accordingly, an optical member 33a, which is assembly of four linear plastic optical transmission mediums having cross-sections whose sides L7 are 0.5 mm length, was obtained as shown in FIG. 11E. In this experiment, the drawing ratio was 400. The optical member 33a was able to be used as an optical link for parallel transmission of four signals, for example.

(Experiment 4)

In this experiment, an optical member 33b was produced by the third process 30 shown in FIG. 4. At first, in the preform piece producing process 31, a clad 95, which has a square cross-section whose sides L8 are 34 mm length and a center circular hole 95a whose diameter L9 is 20 mm, was formed by the melt-extrusion as shown in FIG. 12A. MMA monomer liquid with 7 wt.pct. of DPS, as the refraction index control agent, was put into the circular hole 95a. According to the interfacial gel polymerization, a core 95b was formed in the clad 95, it means that a preform piece 96 was produced (refer to FIG. 12B). Next, the preform piece 96 as the preform was heat-drawn in the drawing process 13 at the temperature range of the softening point to the melting point. In this embodiment, the heating temperature was approximately 210° C. As a result, the optical member 33b, which has a cross-section whose sides L10 are 200 μm length and a core whose diameter L11 is 118 μm, was obtained. The cross-sectional shape of the optical member 33b was approximately similar to that of the preform piece 96. A non-circularity of the core was at most 0.2%. Note that the non-circularity means the ratio between the longest diameter and the shortest diameter. In this experiment, the drawing ratio was 10000. Even when the optical member 33b was bent 360° with 4 mm of the bend radius, transmission loss of the 650 nm wavelength light was not increased. The optical member 33b was able to be preferably used in small spaces such as substrates or the like.

(Experiment 5)

In this experiment, an optical member 33c was produced by the third process 30 shown in FIG. 4. At first, in the preform piece producing process 31, a preform piece 100, which has a circular cross-section whose diameter L12 is 20 mm, was formed as shown in FIG. 13A. Next, two preform pieces 100 were aligned in approximately parallel and adhered together, to be preform piece assembly 102 as shown in FIG. 13B. The adhesion was performed by acrylic adhesive. Next, the preform piece assembly 102 was heat-drawn in the drawing process 13 at the temperature range of the softening point to the melting point. In this embodiment, the heating temperature was approximately 210° C. As a result, the optical member 33c formed of two linear plastic optical transmission mediums, each of which has a circular cross-section with a 0.5 mm diameter L13, was obtained. In this experiment, the drawing ratio was 1600. The optical member 33c was able to be preferably used as a high-speed optical link for two lines of optical signals, for example.

(Experiment 6)

As shown in FIG. 14A-C, a preform piece 103 having a circular cross-section with the GI type refraction index distribution was formed by same method as that of experiment 11 of the Japanese Patent No. 3332922, except that an outer diameter L14 of the preform piece 103 was 20 mm. In the preform piece 103, a clad was formed from PMMA, and a core was formed from copolymer of PMMA and polybenzyl methacrylate which has profile in the co-polymerization ratio. In addition, a preform piece 104 with no refraction index distribution was formed by same method as that of experiment 1 of the Japanese Patent Laid-open Publication No. 57-88405, except that an outer diameter L15 of the preform piece 104 was 20 mm. In the preform piece 104, a clad was formed from PMMA, and a core was formed from polystyrene.

Next, two preform pieces 103 and 104 were aligned in approximately parallel and contact together to be a preform assembly 105, then the preform assembly 105 was heat-drawn in the drawing process 13 at the temperature range of the softening point to the melting point. In this embodiment, the heating temperature was approximately 225° C. As a result, the optical member 33d formed of two linear plastic optical transmission mediums, each of which has a circular cross-section with a 0.5 mm diameter L16, was obtained. The contact position between two optical transmission mediums was welded by heat in the heat-drawing. In this experiment, the drawing ratio was 1600. For example, the optical member 33d was able to be preferably used as an optical link for two lines of optical signals, in which a GI type light guide is a high-speed optical link, and a SI type light guide is a low-speed optical link.

(Experiment 7)

In this experiment, an optical member 33e shown in FIG. 15C was produced by the third process 30 shown in FIG. 4. At first, in the preform piece producing process 31, a preform piece 107 was obtained by putting MMA monomer liquid mixture into a PVDF pipe 107a having a circular cross-section, whose outer diameter L17 is 10 mm and inner diameter L18 is 9 mm, to form a core 107b by radical polymerization as shown in FIG. 15A. Next, eight preform pieces 107 were aligned in a 4×2 matrix to constitute a preform piece assembly 108. In the drawing process 13, the preform assembly 108 was heat-drawn at the temperature range of the softening point to the melting point. In this embodiment, the heating temperature was approximately 210° C. As a result, the optical member 33e, as an optical transmission medium with eight cores, was obtained. Note that the eight preform pieces 107 were welded together by heat in the heat-drawing. The size of the optical member 33e is 400×800 μm, and transmission loss of the 850 nm wavelength light was 0.03 dB/cm in each of the eight cores.

(Experiment 8)

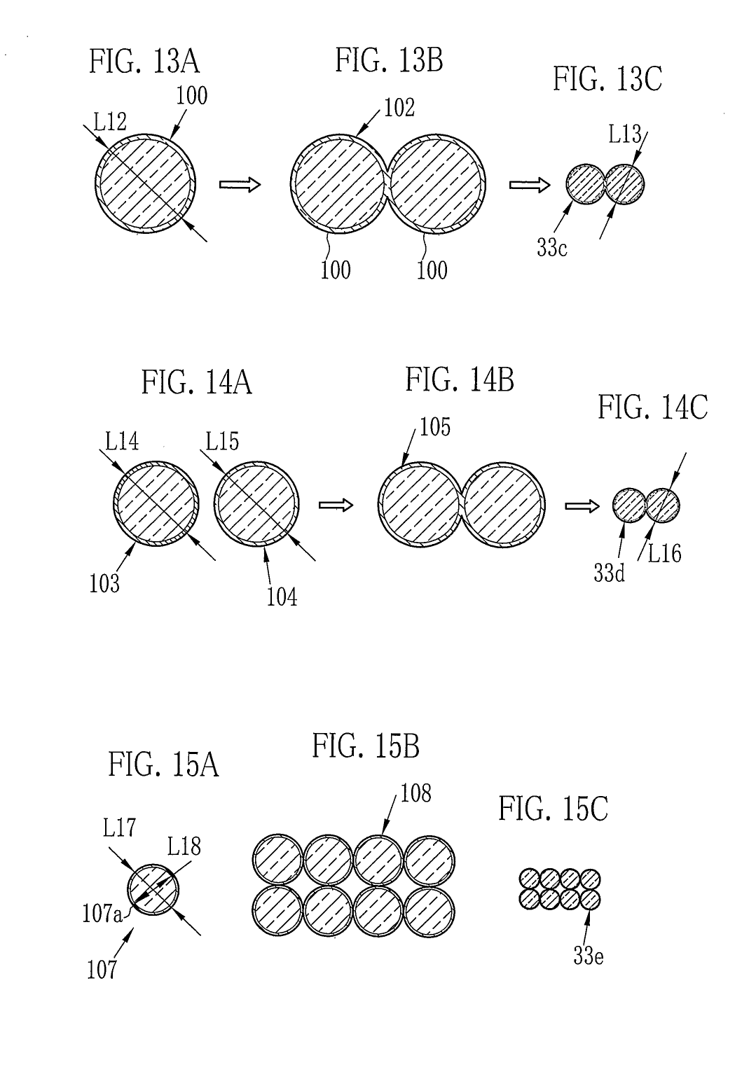

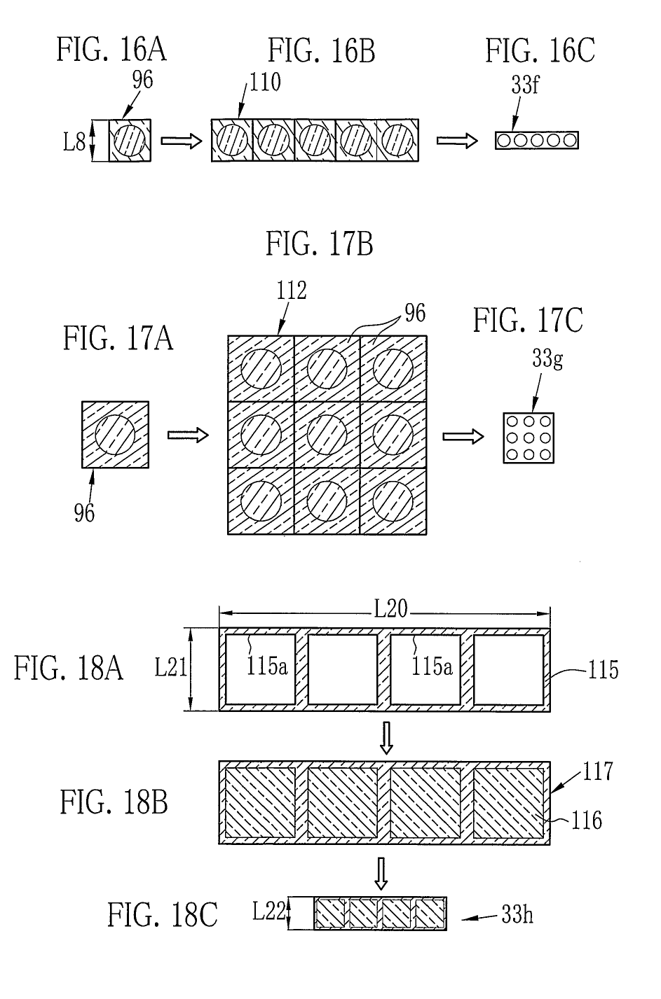

In this experiment, an optical member 33f shown in FIG. 16C was produced by the third process 30 shown in FIG. 4. At first, in the preform piece producing process 31, a preform piece 96 as shown in FIG. 12B was produced by the method same as the experiment 4. Five preform pieces 96 were aligned in a line to constitute a preform piece assembly 110, and then drawn. In the drawing, the five preform pieces 96 were welded together by heat. As a result, the optical member 33f, as a rectangular optical transmission medium with five cores, was obtained. The size of the optical member 33f is 100×500 μm, and transmission loss was 0.05 dB/cm in each of the five cores.

(Experiment 9)

In this experiment, an optical member 33g shown in FIG. 17C was produced by the third process 30 shown in FIG. 4. This experiment is same as the experiment 8, except that nine preform pieces 96 were aligned in a 3×3 matrix to constitute a preform piece assembly 112. By heat-drawing the preform piece assembly 112 in the drawing process, the optical member 33g, which has approximately similar cross-sectional shape to that of the preform piece assembly 112, was obtained. For example, the optical member 33g was able to be used as a two-dimensional multi core plastic optical fiber array for image reading.

(Experiment 10)

In this experiment, an optical member 33h shown in FIG. 18C was produced by the third process 30 shown in FIG. 4. As shown in FIG. 18A, a clad pipe 115, in which four rectangular holes 115a are arranged in a line to form four cores, was produced by melt-extrusion. The clad pipe 115 has a cross-section with long sides L20 of 40 mm and short sides L21 of 10 mm. In the rectangular holes 115a, cores 116 were formed by the core forming process 36, to produce a preform piece 117. The preform piece 117 as the preform was heat-drawn in the drawing process 13 at the temperature range of the softening point to the melting point. In this embodiment, the heating temperature was approximately 210° C. As a result, the optical member 33h, which has a cross-section with a 0.5 mm short side L22 and square light transmitting paths, was obtained. In this experiment, the drawing ratio was 400. The optical member 33h was able to be preferably used as an optical link for parallel transmission, for example.

(Experiment 11)

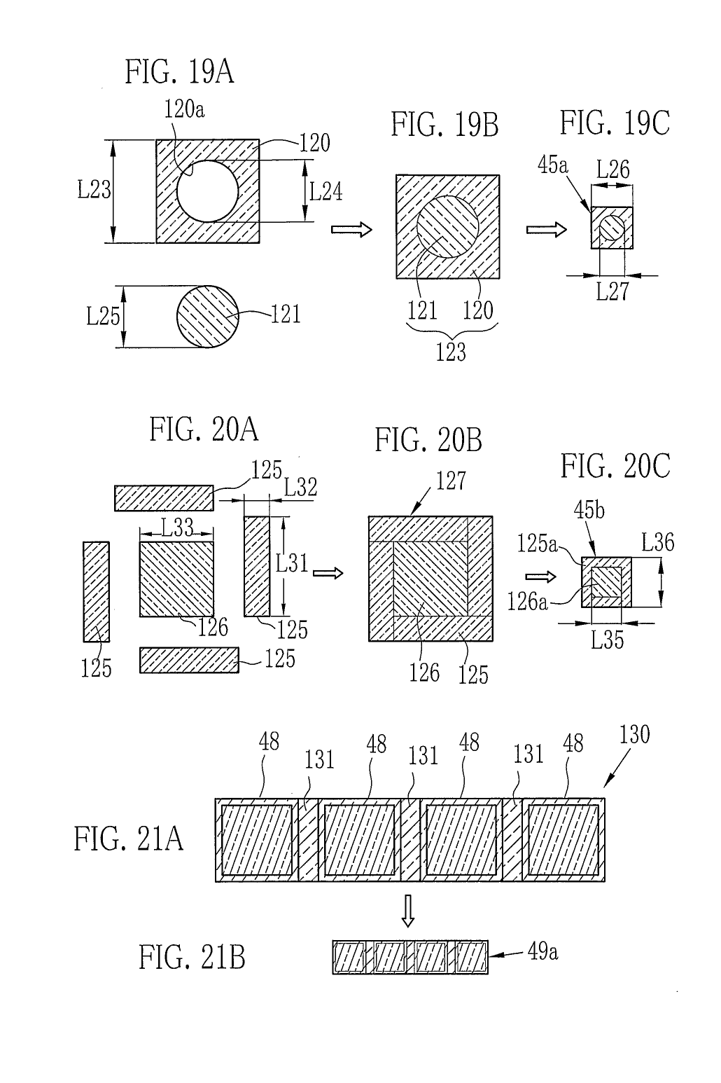

In this experiment, an optical member 45a shown in FIG. 19C was produced by the fourth process 40 shown in FIG. 5. At first, a PVDF pipe (clad pipe) 120, which has a square cross-section whose sides L23 are 20 mm length and a center circular hole 120a whose diameter L24 is 12 mm, was formed by the melt-extrusion as shown in FIG. 19A. Next, a round bar 121 of PMMA having a 12 mm diameter L25 was formed by the melt-extrusion. Then as shown in FIG. 19B, a preform piece 123 was produced by inserting round bar 121 into the circular hole 120a of the clad pipe 120. Next, the preform piece 123 as the preform was heat-drawn in the drawing process 13 at the temperature range of the softening point to the melting point. In this embodiment, the heating temperature was approximately 210° C. As a result, the optical member 45a, which is a plastic optical transmission medium having a square cross-section whose sides L26 are 0.5 mm length and a core whose diameter L27 is 0.3 mm, was obtained. In this experiment, the drawing ratio was 1600. The optical member 45a was able to be preferably used as an optical link for being fixed to an optical signal inputting element or an optical signal receiving element, by an outer plane of the optical member being adhered thereto.

(Experiment 12)

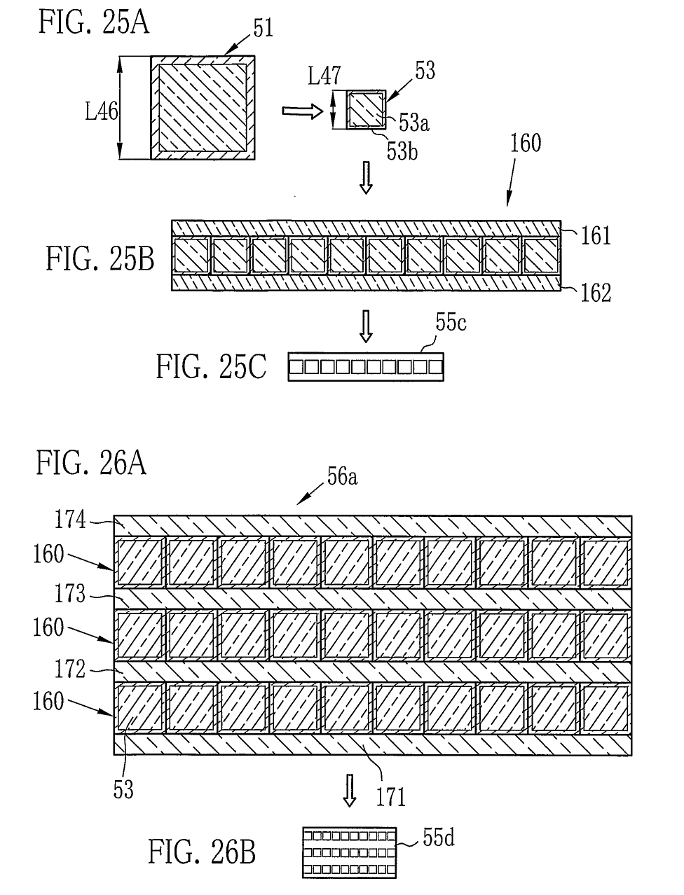

In this experiment, an optical member 45b shown in FIG. 20C was produced by the fourth process 40 shown in FIG. 5. At first, as shown in FIG. 20A, a rectangular bar (preform piece) 125 of PVDF was produced by melt-extrusion. The rectangular bar 125 has 16 mm long sides L31 of 16 mm and short sides L32 of 4 mm. Next, a square bar (preform piece) 126 of PMMA having four sides L33 of 12 mm was formed by the melt-extrusion. Next, in the preform piece assembly producing process, the rectangular bars 125 of PVDF as a clad were heat-pressed around the square bar 126 of PMMA as a core to obtain a preform piece assembly 127 as shown in FIG. 25B. Next, the preform piece assembly 127 was heat-drawn in the drawing process 13 at the temperature range of the softening point to the melting point. In this embodiment, the heating temperature was approximately 210° C. As a result, the optical member 45b, which has a cross-section in which four sides of the core L35 are 0.3 mm length and four sides of the outer periphery of the clad L36 is 0.5 mm length, was obtained. In this experiment, the drawing ratio was 1600. The optical member 45b was able to be preferably used as an optical link for being fixed to an optical signal inputting element or an optical signal receiving element.

(Experiment 13)

In this experiment, an optical member 49a shown in FIG. 21B was produced by the fifth process 46 shown in FIG. 5. At first, in the preform piece producing process 41a, the preform piece 48 same as the preform 12 shown in FIG. 9B was produced. Then in the preform piece assembly producing process 37, four preform pieces 48 were assembled to form a preform piece assembly 130 as shown in FIG. 21A. Between each of the preform pieces 48, a separating plate 131 was sandwiched. For the separating plate 131, polyethylene or the like which has a small Young's modulus, or polyolefin or the like which has low affinity to the clad. In this experiment, polyethylene was used.

In the drawing process 13, the preform piece assembly 130 was heat-drawn in the temperature range of the softening point to the melting point. In this embodiment, the heating temperature was approximately 210° C. Accordingly, the optical member 49a, which is assembly of four square plastic optical transmission mediums having cross-sections whose sides are 0.5 mm length, was obtained as shown in FIG. 21B. The optical member 49a was able to be preferably used for optical transmission, in which plural optical transmission mediums need to be separated at entrance or exit of light. Note that the preform piece 90 shown in FIG. 11C, the preform piece 96 shown in FIG. 12B, the preform piece 123 shown in FIG. 19B or the like can be used instead of the preform piece 48.

(Experiment 14)

In this experiment, a separating plate (not shown) mainly including carbon was used instead of the separating plate 131 of the experiment 13, to prevent the crosstalk. Then in the drawing process 13, a preform piece assembly was heat-drawn in the temperature range of the softening point to the melting point. In this embodiment, the heating temperature was approximately 210° C. Accordingly, the optical member 49, which is assembly of four square plastic optical transmission mediums having cross-sections whose sides are 0.5 mm length, was obtained. Since PMMA including carbon black having high light blocking property was used for the separating plate, the crosstalk between the adjacent optical transmission mediums in the optical transmission was able to be perfectly prevented. Note that the material of the separating plate of this experiment is not limited to the carbon black, and any material which prevents the crosstalk can be used. For example, a material including proper quantity of titanium oxide or aluminum powder can be preferably used. The obtained optical member 49 was able to be preferably used as an optical link for high-speed parallel transmission, for example.

(Experiment 15)

In this experiment, instead of the separating plate 131 of the experiment 13, a preform piece assembly (not shown) was constituted with use of a separating plate (not shown) of elastomer having high flexibility. Then in the drawing process 13, the preform piece assembly was heat-drawn in the temperature range of the softening point to the melting point. In this embodiment, the heating temperature was approximately 210° C. Accordingly, an optical member, which is assembly of four square plastic optical transmission mediums having cross-sections whose sides are 0.5 mm length, was obtained. The cross-section of the preform piece assembly was approximately similar to that of the optical member. In this experiment, since the elastomer having high flexibility was used for the separating plate, the optical transmission medium with high flexibility was obtained. As example, the optical member 33 was able to be preferably used as an optical link for high-speed parallel transmission for a moving part.

(Experiment 16)

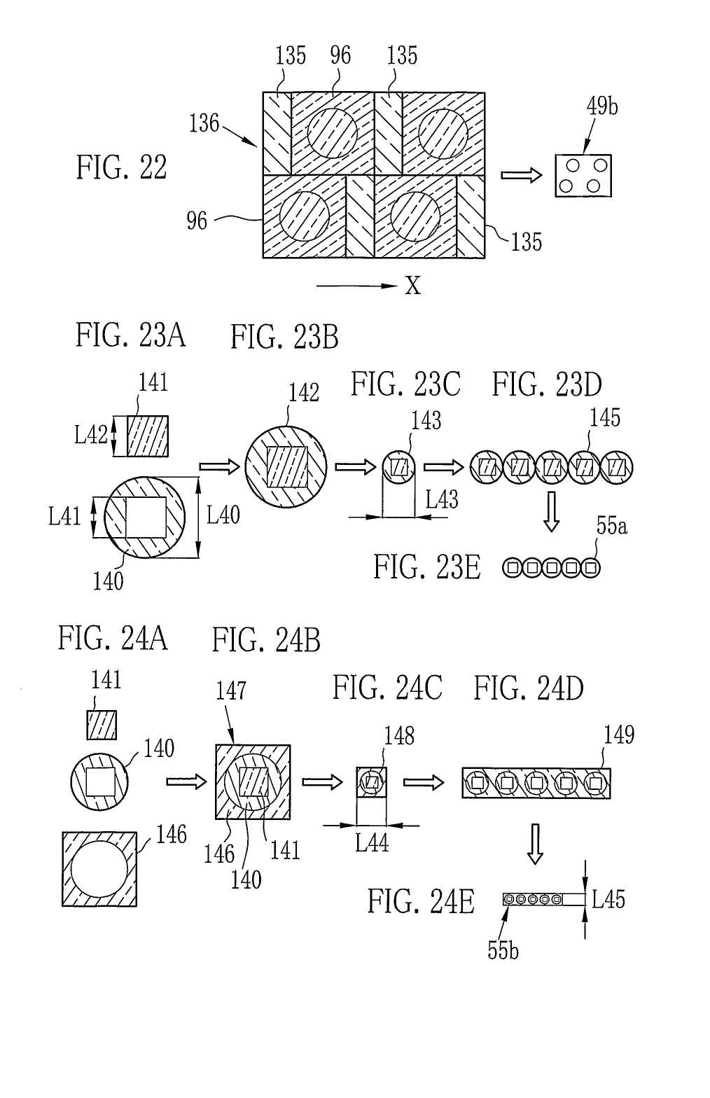

In this experiment, an optical member 49b shown in FIG. 22 was produced by the fifth process 46 shown in FIG. 6. As same as in the experiment 9, the optical transmission mediums were arranged in a matrix. However, in this experiment, PVDF plates 135 as spacer for adjusting a distance between cores were arranged in X direction shown in FIG. 22. A preform piece assembly 136 constituted of the preform pieces 96 and the PVDF plates 135 was heat-drawn in the drawing process, to obtain the optical member 49b having cross-sectional shape approximately similar to that of the preform piece assembly 136. For example, the optical member 49b was able to be used as a two-dimensional multi core plastic optical fiber array for image reading.

(Experiment 17)

In this experiment, an optical member 55a shown in FIG. 23E was produced by the sixth process 50 shown in FIG. 7. At first, a PVDF pipe 140, which has a circular cross-section whose diameter L40 is 15 mm and a center square hole whose sides L41 are 10 mm, was formed by the melt-extrusion as shown in FIG. 23A. In addition, a square bar 141 of PMMA having sides L42 of 10 mm was formed by the melt-extrusion. The square bar 141 was fit into the square hole of the PVDF pipe 140, to form a primary preform piece 142. The primary preform piece 142 was heat-drawn to obtain a secondary preform piece 143 whose diameter L43 is 6 mm. Five secondary preform pieces 143 were arranged in a line to constitute a preform piece assembly 145. The preform piece assembly 145 was heat-drawn at 220° C. By heat in the drawing, the secondary preform pieces 143 were welded each other. As a result, an optical transmission medium as the optical member 55a, which has dimension of 450×2250 μm and five square cores whose sides are 300 μm, was obtained. It was confirmed that shapes of a contour and the core of the optical member 55a is approximately similar to those of the preform piece assembly 145. When the optical member 55a was bent 90° with 20 mm of the bend radius, transmission loss was 0.5 dB increased from before bending. Since the transmission characteristics are easy to change by the external force, the optical member 55a can be used for various kinds of sensors which detect the change of external force by changes of the transmission characteristics.

(Experiment 18)

In this experiment, an optical member 55b shown in FIG. 24E was produced by the sixth process 50 shown in FIG. 7. Although the experiment 18 was approximately similar to the experiment 17, there was a square protector 146 having a center circular hole 146a in the experiment 18, as shown in FIG. 24A. At first, the PVDF pipe 140, the PMMA square bar 141 and the protector 146 were assembled to form a primary preform piece 147. The primary heat-drawing was applied to the primary preform piece 147, to obtain a square secondary preform piece 148 whose sides L44 of a cross-section are 6 mm. Five secondary preform pieces 148 were arranged in a line to constitute a preform piece assembly 149, and then the secondary heat-drawing was applied to the preform piece assembly 149 to obtain the optical member 55b having rectangular shape whose short sides L45 are 250 μm. When the optical member 55b was bent 90° with 20 mm of the bend radius, transmission loss was 0.5 dB increased from before bending.

(Experiment 19)

In this experiment, an optical member 55C shown in FIG. 25C was produced by the sixth process 50 shown in FIG. 7. At first, as shown in FIG. 25A, primary preform piece 51 of a bar shape, whose cross-section is square having sides L46 of 50 mm, was produced in the same condition as the preform piece producing process 31. Next, in the first drawing process 52, the primary preform piece 51 was heat-drawn in the temperature range of the softening point to the melting point. In this embodiment, the heating temperature was approximately 210° C. As a result, a secondary preform piece 53 having a square cross-section whose sides L47 are 5 mm, in which a core 53a is surrounded by a clad 53b whose refraction index is lower than that of the core 53a, was obtained as shown in FIG. 25B. Next, in the preform piece assembly producing process, ten secondary preform pieces 53 were arranged in a line to form a secondary preform piece block 160. On an upper face and a lower face of the secondary preform piece block 160, two PVDF plates 161 and 162 were respectively disposed and heat-pressed for adhesion. The PVDF plates 161 and 162 have a rectangular cross-section of 50 mm×2 mm. As a result, a preform piece assembly 56 having a rectangular cross-section of 50 mm×9 mm was obtained. Next, in the second drawing process, the preform piece assembly 56 was heat-drawn in the temperature range of the softening point to the melting point. In this embodiment, the heating temperature was approximately 210° C. As a result, the optical member 55C having a rectangular cross-section of 2 mm×0.28 mm was obtained. In the optical member 55C, ten optical transmission mediums having a square cross-section of 0.2 mm×0.2 mm are arranged in a line. The cross-sectional shape of the optical member 55C is approximately similar to that of the preform piece assembly 56. For example, the optical member 55C was able to be used as a multi core plastic optical fiber tape for image reading.

(Experiment 20)

In this experiment, an optical member 55d shown in FIG. 26B was produced by the sixth process 50 shown in FIG. 7. In this experiment, the optical transmission mediums were arranged in a matrix with three lines, while in the experiment 19 the optical transmission medium were arranged in one line. In this experiment, as shown in FIG. 26A, the secondary preform piece blocks 160 were respectively arranged between PVDF plates 171 to 174, to constitute a preform piece assembly 56a. Then in the second drawing process 64, the preform piece assembly 56a was heat-drawn at approximately 210° C., to obtain an array-like optical member 55d, in which the optical transmission mediums are arranged in a two-dimension as shown in FIG. 26B. For example, the optical member 55d was able to be used as a two-dimensional multi core plastic optical fiber array for image reading.

(Comparative Experiment)

The preform piece 90 used in the experiment 3, including the square bar clad and the round bar core as shown in FIG. 11C, was heat-drawn as a sample preform in a condition that a temperature in a heater was 290° C. while the softening temperature was 210° C. As a result, a sample having a cross-section of approximately rectangular shape with round corners, and an ellipse core, was obtained. Accordingly, it is found that in this condition, the sample preform cannot be drawn with keeping its shape.

### INDUSTRIAL APPLICABILITY

The present invention is applicable to optical members for optical communication, illumination or the like, especially to the optical members having a complicated cross-sectional shape.

1. A method for producing a plastic optical member, comprising steps of:
forming a preform from polymer, a cross-sectional shape of said preform being non-circular; and
heat-drawing said preform to form said plastic optical member, said cross-sectional shape of said preform being approximately similar to that of said plastic optical member.

2. A method for producing a plastic optical member described in claim 1, wherein said cross-sectional shape of said plastic optical member is one of a polygon, a closed curve, or a combination of line and curve.

3. A method for producing a plastic optical member described in claim 1, wherein said preform is produced by melt-extrusion.

4. A method for producing a plastic optical member described in claim 1, wherein said preform is a preform piece assembly constituted by assembling plural preform pieces.

5. A method for producing a plastic optical member described in claim 4, wherein said preform piece assembly includes at least one secondary preform piece formed by heat-drawing a primary preform piece formed from polymer.

6. A method for producing a plastic optical member described in claim 4, wherein said preform piece assembly is constituted by assembling plural kinds of preform pieces having different shapes.

7. A method for producing a plastic optical member described in claim 4, wherein said preform piece assembly is constituted by assembling plural kinds of preform pieces having different optical properties.

8. A method for producing a plastic optical member described in claim 4, wherein said preform piece includes a core to be a light transmitting path and a clad having a refraction index rower than that of said core.

9. A method for producing a plastic optical member described in claim 8, wherein said clad surrounds said core.

10. A method for producing a plastic optical member described in claim 9, wherein said preform piece further includes a protector.

11. A method for producing a plastic optical member described in claim 10, wherein said protector surrounds said clad.

12. A method for producing a plastic optical member described in claim 11, wherein said preform piece assembly is constituted by disposing a separating member between said preform pieces, and said separating member allows to separate said preform pieces after said heat-drawing.

13. A method for producing a plastic optical member described in claim 12, wherein said separating member contains a light shielding material.

14. A method for producing a plastic optical member described in claim 8, wherein said core formed mainly from (meth) acrylic ester, and said clad mainly includes fluorine resin.

15. A method for producing a plastic optical member described in claim 10, wherein said core is formed mainly from (meth) acrylic ester, said clad mainly includes fluorine resin, and said protector is formed mainly from (meth) acrylic ester.

16. A method for producing a plastic optical member described in claim 14 or claim 15, wherein at least one of said core has a refractive index profile, in which a refractive index changes from a center to a periphery of said core.

17. A method for producing a plastic optical member described in claim 16, wherein said refractive index profile is a graded index type, in which said refractive index gradually decreases from said center to said periphery of said core in a continuous fashion.

18. A method for producing a plastic optical member described in claim 16, wherein said refractive index profile is a multi-step index type, in which said refractive index gradually decreases from said center to said periphery of said core in a step-wise fashion.

19. A method for producing a plastic optical member described in claim 8, wherein said core includes light scattering particles.

20. A method for producing a plastic optical member described in claim 4, wherein said preform piece assembly is constituted by adhering said preform pieces each other.

21. A method for producing a plastic optical member described in claim 4, wherein said preform piece assembly is constituted by welding outer peripheries of said preform pieces each other.

22. A method for producing a plastic optical member described in claim 21, wherein said welding is performed by heat before said heat-drawing.

23. A method for producing a plastic optical member described in claim 21, wherein said welding is performed by heat in said heat-drawing.

24. A method for producing a plastic optical member described in claim 1, wherein said heat-drawing is performed at a heating temperature T in a range of 80° C.≦T≦500° C.

25. A method for producing a plastic optical member described in claim 1, wherein said heat-drawing is performed at a heating temperature T in a range of (Ts−50° C.)≦T≦(Ts+50° C.), When Ts is a softening temperature of a main polymer of said preform.

26. A plastic optical member produced by the method described in claim 8, comprising:
a core having a circular cross-section; and
a clad having an approximately polygonal cross-section.

27. A plastic optical member described in claim 26, wherein said cross-section of said clad has a square, rectangular or regular hexagonal shape.

28. A plastic optical member produced by the method described in claim 10, comprising:
a core having a circular cross-section; and
a protector having an approximately polygonal cross-section.

29. A plastic optical member described in claim 28, wherein said cross-section of said protector has a square, rectangular or regular hexagonal shape.

30. A plastic optical member produced by the method described in claim 8, comprising:
a core having an approximately polygonal cross-section; and
a clad having an approximately polygonal cross-section.

31. A plastic optical member described in claim 30, wherein said cross-section of said core has a square or rectangular shape, and said cross-section of said clad has a square, rectangular or regular hexagonal shape.

32. A plastic optical member produced by the method described in claim 10, comprising:
a core having an approximately polygonal cross-section; and
a protector having an approximately polygonal cross-section.

33. A plastic optical member described in claim 32, wherein said cross-section of said core has a square or rectangular shape, and said cross-section of said protector has a square, rectangular or regular hexagonal shape.

34. A plastic optical member described in claim 32, wherein said cross-section of said clad has a circular shape.

35. A plastic optical member described in claim 9, comprising plural cores arranged in two-dimension in a clad.

36. A plastic optical member described in claim 35, wherein a cross-section of said core has a circular shape, and a cross-section of said clad has a square, rectangular or regular hexagonal shape.

37. A plastic optical member described in claim 26, wherein said cross-section of said core is at least 100 μm² in area.

38. A plastic optical member described in claim 26, further comprising a protective coat on an outer periphery of said clad, said protective coat being formed by coating radiation-hardening resin and radiating for hardening said coating.

39. A plastic optical member described in claim 26, further comprising a protective coat on an outer periphery of said clad, said protective coat being formed by extrusion of thermoplastic resin.
